(19) United States
(12) Patent Application Publication
(10) Pub. No.: US 2009/0221441 A1
(43) Pub. Date: Sep. 3, 2009

(54) THREE-DIMENSIONAL CELLULAR ARRAY CHIP AND PLATFORM FOR TOXICOLOGY ASSAYS

(75) Inventors: Moo-Yeal Lee, Latham, NY (US); Anand K. Ramasubramanian, Berkeley, CA (US); Douglas S. Clark, Orinda, CA (US); Jonathan S. Dordick, Schenectady, NY (US)

Correspondence Address: ELMORE PATENT LAW GROUP, PC, 515 Groton Road, Unit 1R, Westford, MA, 01886, US

(73) Assignees: Rensselaer Polytechnic Institute; Regents of the University of California, Oakland, CA (US)

(21) Appl. No.: 12/091,990

(22) PCT Filed: Oct. 31, 2006
(86) PCT No.: PCT/US06/42345

§ 371 Date: Dec. 22, 2008

Related U.S. Application Data
(60) Provisional application No. 60/732,341, filed on Nov. 1, 2005.

(51) Int. Cl. C40B 30/06; C40B 40/02; C40B 50/18

(52) U.S. Cl. 506/10; 506/14; 506/32

(57) ABSTRACT

The present invention is directed to a screening platform employing a miniaturized three-dimensional cell chip for high-throughput toxicology screening of test and lead compounds, prodrugs, drugs and P-450 generated drug metabolites. To this end, the three-dimensional cell chip, employs human cells encapsulated in a matrix (e.g., collagen or alginate gels) in volumes as small as 10 nL arrayed on a functionalized substrates (e.g., glass microscope slides) for spatially addressable screening against multiple test compounds. With the present platform, over 3,000 cell-matrix islands may be spotted providing for simultaneous screening against multiple compounds at multiple doses and in high replicate.

### RELATED APPLICATION

This application claims the benefit of U.S. Provisional Application No. 60/732,341, filed on Nov. 1, 2005. The entire teachings of the above application are incorporated herein by reference.

### GOVERNMENT SUPPORT

The invention was supported, in whole or in part, by grant NIH ES-012619 from the National Institutes of Health. The Government has certain rights in the invention.

### BACKGROUND OF THE INVENTION

Over the past few years, advances in bioinformatics, genomics, and proteomics have resulted in the identification of promising drug targets. An estimate suggests that the number of molecular targets will rise from 500 to 4000, with the completion of the Human Genome project (Drews, J., Drug discovery: A historical perspective, Science, 287, 1960-1964 (2000)). This increase would mean an even greater increase in the potential drug candidates that could be of interest for these targets.

However, an increase in the number of potential drug candidates does not necessarily translate to an increase in the successful development of therapeutics, since a very large number of potential drug candidates fail in the later stages of drug development due to lack of efficacy, unfavorable pharmacokinetic properties and, just as importantly, due to toxicity. (Li, A. P., Screening for human ADME/Tox drug properties in drug discovery, Drug Discov Today, 6, 357-366 (2001)).

For the pharmaceutical industry, these failures manifest as deleterious increases in the development time and cost of new chemical entities (NCE) progressing to pharmaceuticals.

The successful development and selection of the most active drug leads, and hence of therapeutics, demand robust and reliable screening systems.

Traditionally, pharmaceutical companies have used a set of specific high-throughput screening (HTS) assays in several areas of research, including toxicological assays. These assays are carried out in multi-well systems like 96- or 384-well plates and occasionally in 1536-well plates with a two-dimensional (2D) cell monolayer as a screening target. (Fox, S., Farr-Jones, S., Sopchak, L., Boggs, A., and Comley, J., High-throughput screening: searching for higher productivitiy, J Biomol Screen, 9, 354-358 (2004); Wunder, F., Stasch, J. P., Huetter, J., Alonso-Alija, C., Hueser, J., and Lohrmann, E., A cell-based cGMP assay useful for ultra-high-throughput screening and identification of modulators of the nitric oxide/cGMP pathway, Anal Biochem, 339, 104-112 (2005)). However, the multi-well plate format has inherent limitations in terms of the reagent addition to, or removal from, the plate, washing the cells to remove the reagents and, in many cases, the relatively larger volume of expensive reagents needed for the assays.

Furthermore, high-throughput toxicology assays are limited in that using a two-dimensional (2D) cell monolayer prevents the formation of in vivo tissue-like structures, which are more representative of the in vivo response to drugs and drug candidates.

Recently, alternative platforms such as cellular micro-systems, which are typically built using photolithographic techniques, have been developed to replace the traditional multi-well systems (Albrecht, D. R., Tsang, V. L., Sah, R. L., and Bhatia, S. N., Photo- and electropatterning of hydrogel-encapsulated living cell arrays, Lab Chip, 5, 111-118 (2005)). Cells seeded either into micro-wells or onto micro-patterned surfaces have found several applications including cell-based sensors, single cell differentiation studies, and cellular function studies (Wang, Y., Klock, H., Yin, H., Wolff, K., Bieza, K., Niswonger, K., Matzen, J., Gunderson, D., Hale, J., Lesley, S., Kuhen, K., Caldwell, J., and Brinker, A., Homogeneous high-throughput screening assays for HIV-1 integrase 3′-processing and strand transfer activities, J Biomol Screen, 10, 456-462 (2005); Flaim, C. J., Chien, S., and Bhatia, S. N., An extracellular matrix microarray for probing cellular differentiation, Nat Methods, 2, 119-125 (2005); Silva, J. M., Mizuno, H., Brady, A., Lucito, R., and Hannon, G. J., RNA interference microarrays: high-throughput loss-of-function genetics in mammalian cells, Proc Natl Acad Sci USA, 101, 6548-6552 (2004)).

Compared to 2D monolayer culture, three-dimensional (3D) culture of cells within extracellular matrices such as collagen maintains specific biochemical functions and morphological features of human cells similar to the corresponding tissue in vivo (Abbott, A., Biology's new dimension, Nature, 424, 870-872 (2003); Zahir, N. and Weaver, V. M., Death in the third dimension: Apoptosis regulation and tissue architecture, Curr. Op. Gen. Dev., 14, 71-80 (2004)).

Applicants have developed, and previously described, a microscale toxicology assay platform called the Metabolizing Enzyme Toxicology Assay Chip (MetaChip) that integrates the high throughput metabolite-generating capability of P450 catalysis with human cell-based screening. This assay platform is disclosed in U.S. patent application Ser. No. 10/287,442 filed Nov. 1, 2002 and published as U.S. Application Publication 20030162284, the contents of which are incorporated herein by reference in its entirety.

Although reasonable emphasis has been placed on the importance of three-dimensional cell culture systems for studies on cellular differentiation and metabolism, relatively little effort has been directed at using three-dimensional cell cultures for toxicology assays, in general and in particular miniaturized three-dimensional cell cultures for such applications.

### SUMMARY OF THE INVENTION

The present invention addresses a long-felt need for a high-throughput, three-dimensional cell culture microarray platform useful for toxicology assays and screening. The present invention is directed to a high-throughput screening platform employing a miniaturized three-dimensional cell chip for high-throughput toxicology screening of test and lead compounds, prodrugs, drugs and cytochromes P450 (abbreviated herein as P450) generated drug metabolites.

The three-dimensional cell chip, or as referred to herein, the Data Analysis Toxicology Assay Chip (DataChip) employs human cells encapsulated in a matrix (e.g., collagen or alginate gels) in volumes as small as 10 mL arrayed on a functionalized substrates (e.g., glass microscope slides) for spatially addressable screening against multiple test compounds.

With the present DataChip platform, over 3,000 cell-matrix islands can be spotted on the three-dimensional cell chip, and hence a single microscope slide may be used for screening against multiple compounds at multiple doses and in high replicate. In fact, it is anticipated that using the present platform, at least 5,000 individual spots can be deposited per 25×75 mm microscope slides with 10 nL spots.

The present invention is directed to a three-dimensional cell chip for microarray analysis comprising a chemically modified glass slide having spotted thereon a plurality of independent spots, each spot comprising a matrix bottom layer, and a matrix surface layer containing cells. The modification of the glass slide may comprises functionalization with 3-(aminopropyl)trimethoxysilane (APTMS) followed by functionalization with poly(styrene-co-maleic anhydride) (PS-MA). It may also comprise functionalization with a coating of methyltrimethoxysilane (MTMOS).

In one embodiment, the matrix bottom layer comprises a poly-L-lysine (PLL)-barium chloride mixture and the matrix surface layer containing cells comprises alginate.

The three dimensional cell chip of the present invention may also comprise a middle layer deposited between the matrix bottom layer and the matrix surface layer containing cells. This middle layer may comprise hyaluronan or its acid or derivatives.

In one embodiment, the matrix of the matrix bottom layer or the matrix of the matrix surface layer containing cells may be selected from sol-gels, inorganic materials, organic polymers, hybrid inorganic-organic materials, biological materials, or any combination thereof.

In one embodiment the matrix of the matrix bottom layer or matrix of the matrix surface layer containing cells is a biological material and is collagen, preferably Type I collagen. Alternatively the biological material may comprise alginate.

The three-dimensional cell chips (DataChips) of the present invention may comprise at least 500, at least 1000, at least 3000 or at least 5000 independent spots. More preferably, the DataChips comprise at least 560 independent spots or 1080 independent spots. These independent spots may be in the size range of about 0.6 mm in size with a center-to-center distance of about 1.2 mm. The spots may be regularly spaced or placed in a predetermined pattern or array.

While not of primary importance, the cells contained within the matrix surface layer are encapsulated in a substantially regular pattern within the matrix.

In one embodiment of the invention, the cells are mammalian cells. The mammalian cells may be selected from the group consisting of human hepatoma cells, Hep3B cells, human embryonic kidney cells, A293T cells and breast carcinoma cells, MCF-7 cells or any cancerous or transformed cell line.

In one embodiment of the invention is a method of preparing a three-dimensional cell chip for microarray analysis comprising the steps of functionalizing a glass slide, wherein functionalization comprises treatment with 3-(aminopropyl)trimethoxysilane (APTMS) followed by treatment with poly(styrene-co-maleic anhydride) (PS-MA), and depositing a plurality of individual spots onto the functionalized glass slide said deposition comprising the steps of depositing a plurality of individual spots comprising a matrix bottom layer atop the functionalized glass slide, depositing a matrix surface layer containing cells on the surface of the matrix bottom layer.

The prepared DataChip may further be incubated the functionalized glass slide with deposited individual spots in cell culture media.

In one embodiment of the invention is a process for assaying cytotoxic effects of test compounds on cells comprising the steps of preparing a three-dimensional cell chip, preparing a test compound chip, stamping together the three-dimensional cell chip and the test compound chip, and calculating IC₅₀ values of the test compounds based on live cell count. This process may further comprise the step of correlating IC₅₀ values with cytotoxicity profiles of the test compounds.

According to the present invention, the duration of stamping step is about 6 hours. This stamping step may, however, range from 4-7 hours. Measurement of the live cell count in the method of the present invention may be accomplished using a fluorescence-based or colorimetric assay.

In one embodiment of the invention is provided a microarray platform for toxicology assays comprising a three-dimensional cell chip, a test compound chip, and a device for measurement of live cell count.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side view of alternate embodiments of the DataChip of the invention. The upper panel shows the DataChip employing collagen as the matrix while the lower panel shows the DataChip employing alginate as the matrix.

FIG. 2 is a schematic of one embodiment of the DataChip toxicology assay platform of the present invention. The figure illustrates the dual-slide nature of the platform whereby a DataChip is coupled to a test compound chip, here a MetaChip.

### DETAILED DESCRIPTION OF THE INVENTION

A description of preferred embodiments of the invention follows.

Disclosed herein is a miniaturized or micro-scale high-throughput toxicology assay platform and methods of use thereof.

According to the present invention the Data Analysis Toxicology Assay Chip (DataChip) toxicology assay platform comprises two key components; a three dimensional cell chip (DataChip) and a test compound chip each prepared on a functionalized substrate. The test compound chip, as described herein, may comprise a Drug Chip (DrugChip) or a Metabolizing Enzyme Toxicology Assay Chip (MetaChip).

Integral to the platform is the miniaturized or micro-scale three-dimensional cellular array chip (three-dimensional cell chip; DataChip) of the invention. The DataChip is a microarray consisting of a spatially addressable pattern of cells encapsulated in a three-dimensional hydrogel matrix, such as collagen or alginate, which supports cell growth at the microscale. Cells are seeded within the three-dimensional matrix material and are spotted onto a functionalized substrate (e.g., a functionalized glass microscope slide) using a standard microarrayer. The DataChip is then incubated in culture medium to support cell growth over time scales relevant for toxicity analysis (anywhere from 1 to 7 days).

The DataChip is useful for in vitro toxicological assessment of test and lead compounds, prodrugs, drugs and their P450-generated metabolites in a high throughput manner. To this end, the DataChip is coupled to a test compound chip by a unique “stamping” technique and then assayed for cytotoxicity. The cytotoxicity assays are performed in volumes as low as 10 nL, and have been coupled to human P450 metabolite generation.

The IC₅₀ values measured using the DataChip toxicology assay platform are comparable to those obtained from conventional well plate assays. Thus, the DataChip toxicology assay platform represents a high throughput microscale alternative to conventional in vitro multi-well plate platforms for toxicology assays at early phases of drug development. Using the DataChip toxicology assay platform, analysis of drug candidates and their metabolites can be performed at speeds consistent with the large number of compounds present at early stages of drug discovery.

### Substrate Functionalization

According to the present invention, efficient construction of miniaturized three-dimensional (3D) cell culture on a glass slide requires an effective surface modification strategy, whereby live cells can be encapsulated into extracellular matrices. The encapsulation procedure should be fast and simple, and applicable to a wide range of human cells. In addition, it should maintain a three-dimensional structure which supports cell growth. Direct deposition of cell-encapsulated collagen drops on glass substrates has shown significant drawbacks such as non-specific detachment of collagen drops from the slide and spreading of the aqueous-based spots on the surface.

The present invention alleviates these problems via chemical modification or functionalization of the underlying substrate. As used herein “chemical modification or functionalization” includes contacting, treating or coating a substrate with a compound or chemical whereby the surface of the substrate is altered in any manner which aids or facilitates the attachment, either ionic or covalent, of another moiety, preferably a matrix, to the surface of the substrate. Chemical modification or functionalization may be achieved by treatment, contacting, coating or any method which brings the substrate into sufficient proximity to the compound or chemical which may alter the surface properties of the substrate.

While glass microscope slides are a preferred suitable substrate, the present invention contemplates the use of other substrates including, but not limited to, glass, plastic and silicon, with the selection of a suitable substrate being driven by the stability and robust nature of attachment thereto.

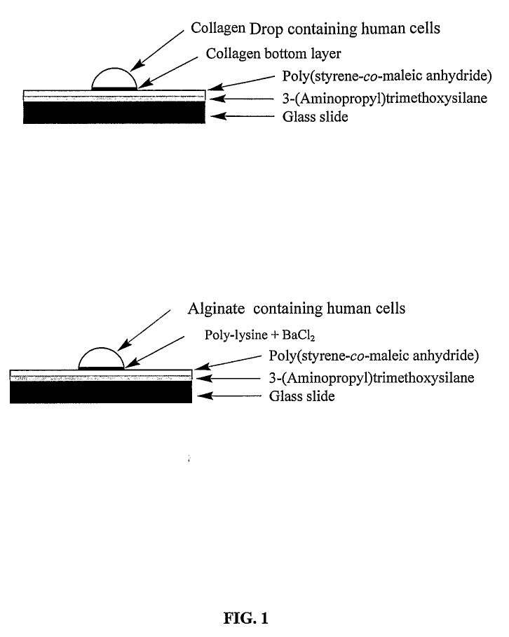

With commercially available microscope slides, collagen suspensions spread, presumably due to the hydrophilic nature of the glass surface imparted by the silanol groups. Functionalization of the glass slides alters the interfacial property of the glass making it sufficiently hydrophobic such that collagen does not spread on the surface, while maintaining a strong affinity for collagen to ensure robust attachment of the spots. Functionalization also serves to reduce the difference of interfacial properties between collagen-gel drops containing cells and the slide surface by facilitating the covalent attachment of the bottom layer of collagen to the modified surface via amide bond formation (see FIG. 1).

In one embodiment of the present invention, a microscale surface of collagen spots is covalently attached on the surface of a glass microscope slide via 3-(aminopropyl) trimethoxysilane (APTMS) and poly(styrene co-maleic anhydride) (PS-MA) treatment.

During the collagen immobilization process, the acid anhydride groups on the PS-MA react with the free amino groups on the surface of the glass slide (from APTMS) and with those on the collagen backbone. In addition, the lipophilic polymer chains on the PS-MA interact with each other via hydrophobic interactions resulting in a thin coating.

In a further embodiment the glass slide may be functionalized with methyltrimethoxysilane (MTMOS).

In a further embodiment, APTES (aminopropyltriethoxysilane) may be used in place of APTMS.

In a further embodiment, PTMOS (propyltrimethoxysilane) and OTMOS (octyltrimethoxysilane) may be used in place of MTMOS.

### Preparation of the Three-Dimensional Cell Chip (DataChip)

The three-dimensional cell chip (DataChip) of the present invention employs mammalian cells encapsulated or seeded in a matrix array of any of sol-gels or other inorganic materials, organic polymers, hybrid organic-inorganic materials, and biological materials and spotted onto functionalized glass slides. Preferred matrices include collagen, alginate, hyaluronic acid (hyaluronan), poly(vinyl alcohol), and polyacrylates.

Referring to FIG. 1, two DataChips are shown. The upper panel represents a DataChip prepared on a glass substrate functionalized with APTMS and then with PS-MA. Upon this functionalized glass substrate is deposited an array of collagen matrix spots. Further upon the collagen spots is deposited a collagen matrix or gel drop containing cells. It is noted that in this embodiment, a middle layer of hyaluronan may optionally be deposited (although not shown in the figure).

In the lower panel of FIG. 1 is shown a DataChip functionalized in the same manner as in the upper panel but having a bottom matrix layer of poly-lysine and barium (from barium chloride). Atop the poly-lysine:barium spots is deposited on an alginate matrix containing cells.

The three-dimensional cell chip (DataChip) is a microarray comprising cells encapsulated in a three-dimensional gel or matrix deposited in a substantially regular pattern of matrices on the glass slide (DataChip). In one embodiment the matrix is collagen gel. As used herein, a “substantially regular pattern of matrices” means an arrangement which is uniform or approximating an even distribution on the substrate. One of skill in the art will appreciate that producing a perfect distribution of matrix is practically impossible. The goal of the distribution for use in the present invention is to obtain a distribution which serves to give reproducible outcomes in the assay being evaluated.

In one embodiment of the invention, a bottom array of collagen is prepared on a glass slide chemically modified or functionalized by pre-coating with PS-MA. The matrix used in the present invention is arrayed and/or deposited to produce independent spots. As used herein “independent spots” are spots which are in identifiably separate locations and support the toxicology assay being performed absent any substantial interference from neighboring spots. They do not have to be and are not typically separated by any non-matrix or physical barrier.

Once the bottom array of collagen islands are spotted and dried, a layer of hyaluronan may be optionally deposited atop the dried collagen spots. The presence of hyaluronan layer enhanced more robust attachment of the collagen drops containing the cells, presumably through electrostatic interactions.

A collagen solution containing mammalian cells (initial seeding density for MCF7s: 3×10⁶ cells/mL) is subsequently printed atop the island of bottom collagen or atop the islands of bottom collagen having the hyaluronan layer deposited thereon.

The volume of the cell-containing spots may range from about 10-100 nL, from about 20-80 nL or from about 30-60 nL. These samples may be arrayed depending on the size of the substrate and may be in a regular or predetermined pattern. The pattern selected need not be a regular pattern or evenly arrayed. Regular arrays may include 14×40, 20×54, or larger arrayed patterns.

For example, in the case of a 20×54 pattern, 45 regions (5×9) are produced each with a 4×6 array. Larger numbers of spots would necessitate a larger array and creating such larger arrays are contemplated within the invention.

In cell-containing samples with a volume of 30 nL each on a 14×40 spot array deposited on a 25×75 mm² glass slide, the spot diameter is 0.6 mm (close to the expected size for hemispherical spots), the thickness is approximately 50 μm, and the center-to-center distance is 1.2 mm.

In one embodiment, a single DataChip containing 1,080 individual cell cultures, used in conjunction with the complementary human P450-containing MetaChip, can simultaneously provide IC₅₀ values for nine compounds and their metabolites from CYP1A2, CYP2D6, and CYP3A4, and a mixture of the three P450s designed to emulate the human liver. Similar responses are obtained with the DataChip and conventional 96-well plate assays, demonstrating that the near 2.000-fold miniaturization does not influence the cytotoxicity response.

Once prepared, the three-dimensional cell chip (DataChip) is incubated in cell culture media to sustain the growth of the cells prior to toxicology assays.

A wide variety of cells may be used in the DataChip toxicology assay platform of the present invention. Determination of which cell to use depends on the purpose of the particular experiment. For example, in optimizing a new cancer drug lead, one experiment would use a cytotoxicity assay employing cancerous cells, where cell death is the sought after result. In another experiment, the same array can be used in combination with normal (non-cancerous) cells, for example, for the same organ as the cancerous cells, in order to determine the toxicity and selectivity of the optimized drug leads. Correlation of the two experiments allows optimized lead compounds to be ranked according to their desirable toxicity to cancer cells versus undesirable toxicity to normal cells. Alternatively, normal and transformed cells can be used to screen for toxicity of drug candidates unrelated to cancer therapy.

Cells that can be used, or the tissues/organs they can be derived from, include, but are not limited to bone marrow, skin, cartilage, tendon, bone, muscle (including cardiac muscle), blood vessels, corneal, neural, brain, gastrointestinal, renal, liver, pancreatic (including islet cells), lung, pituitary, thyroid, adrenal, lymphatic, salivary, ovarian, testicular, cervical, bladder, endometrial, prostate, vulval, esophageal, etc.

Also included are the various cells of the immune system, such as T lymphocytes, B lymphocytes, polymorphonuclear leukocytes, macrophages, and dendritic cells.

In addition to human cells, or other mammalian cells, other organisms can be used. For example, in testing for environmental effects of an industrial chemical, aquatic microorganisms that could be exposed to the chemical can be used. In still another example, organisms such as bacteria that are genetically engineered to possess or lack a certain trait could be used. For example, in the optimization of an antibacterial lead compound for combating antibiotic resistant organisms, the cell assay could include cells that have been engineered to express one or more genes for antibacterial resistance.

### Preparation of the Test Compound Chip (DrugChip or MetaChip)

The DataChip toxicology assay platform of the present invention requires coupling of the DataChip to a test compound chip. Test compound chips include DrugChips and MetaChips.

As used herein, DrugChips contain test or lead compounds deposited on bottom islands of matrix spots whereas MetaChips comprise test or lead compounds deposited on bottom islands of matrix spots which further contain human P450 isoforms used to generate biologically active metabolites of compounds.

Common P450 isoforms that are applicable to the MetaChip are 1A1, 1A2, 1B1, 2A6, 2B6, 2C8, 2C9, 2C18, 2C19, 2D6, 2E1, 2J2, 3A4, 3A5, 3A7, 4B1, 4F8, 4F12, 7B1, 26B1, 27A1, and 39A1. In addition to P450s other Phase I metabolism-based enzymes can be used, including flavin monooxygenases, monoamine oxidases, various esterases, quinone reductases, peroxidases, and alcohol dehydrogenases. In addition to Phase I enzymes, Phase II metabolism-based enzymes can be used, including uridinyl glucuronosyl transferases (particularly isoforms 1A1, 1A3, 1A4, 1A5, 1A6, 1A7, 1A8, 1A9, 1A0, 2B4, 2B7, 2B10, 2B1, 2B15, and 2B17), epoxide hydrolases, N-acetyl transferases, glutathione S-transferases, sulfotransferases (particularly isoforms 1A1, 2B1a, 2B1b, and 1E1), and catechol O-methyltransferases. In addition to the aforementioned enzymes and their isoforms, a wide range of synthetically relevant enzymes from human and non-human sources can be used, including those contained within Enzyme Commission (EC) Classes 1-6, e.g., Class 1 (oxidoreductases), Class 2 (transferases), Class 3 (hydrolases), Class 4 (lyases), Class 5 (isomerases), and Class 6 (ligases).

Both DrugChips and MetaChips are prepared atop chemically modified or functionalized substrates. Functionalization of the substrate, preferably a glass slide is by combined treatment with PS-MA, MTMOS, or other reagent as described herein.

The test compound chip comprises a typical spot size varied from about 5-100 nL, about 10-80 nL or from about 30-60 nL and contains hundreds of test or lead compounds (e.g., drugs, prodrugs or drug candidates). After pre-incubation of the test compound chip, a solution of test or lead compound is applied to either the collagen bottom spots or P450 bottom collagen spots using a microarrayer.

### Coupling of the DataChip to the Test Compound Chip (DrugChip or MetaChip): The Stamping Process

As used herein “stamping” is a dual-slide process of coupling a DataChip to a test compound chip. This coupling is not orientation dependant. In other words, the DataChip may be placed atop the test compound chip or vice versa.

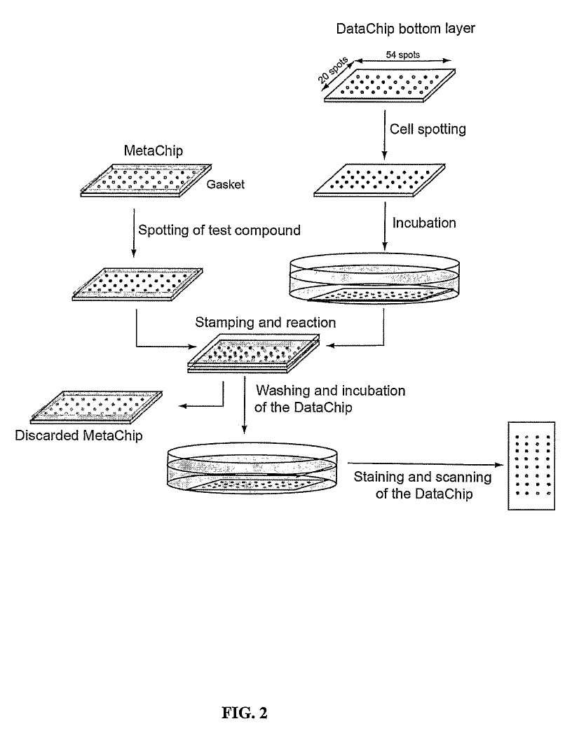

Referring now to FIG. 2, in the stamping process, cell-containing spots arrayed on the DataChip are coupled in a one-to-one manner with complementary spots on the test compound chip. As used herein “coupling” occurs when the complementary DataChip spots are in fluid communication with spots on the test compound chip. Therefore coupling does not require direct contact between the surfaces of the glass slides nor does it require direct contact between the collagen spots at complementary sites. Coupling occurs when communication is effected between the complementary spots. This can occur via a fluid column of contact across the interfacial space between the slides.

As illustrated in FIG. 2, after coupling or incubation for sufficient time (typically 6 hours at 37° C.) to allow either the synthesis of P450-generated metabolites with subsequent transfer into the cell-containing spots as with a MetaChip, or synthesis of lead compound analogs via a multiple enzyme-containing chip that is a variant of the MetaChip (hereafter called the Multizyme Chip), or after such time as to allow transfer of test or lead compounds into the cell-containing spots as with a DrugChip, the DataChip-MetaChip, DataChip-DrugChip, or DataChip-Multizyme Chip pairs are separated.

Stamping times with the attendant coupling of the slides may vary and it is within the skill in the art using no more than routine experimentation to determine the appropriate coupling time as may be necessary for the particular cell type selected for the toxicology screen of interest.

Once stamping is complete, the DataChip is then rinsed to remove any excess of drug accumulated in the matrix drops containing the cells. It has been discovered that rinse times of approximately 2 hours are typical for the platform but may vary depending on the cell type. It is believed that one skilled in the art, armed with the instant disclosure, would be able to optimize rinse times for various cell types, requiring no more that routing experimentation.

After rinsing, the DataChip is incubated for several days (e.g., 3 days for most cell lines) in serum-containing media. Afterwards the cells may be stained with green fluorogenic calcein AM to determine the percentage of live cells in the matrix drops using a microarray scanner. The cytotoxicity profiles of the test and lead compounds are obtained as a function of drug concentration and IC₅₀ values (the drug concentration at which 50% of the cell growth is inhibited) may also be calculated.

It is demonstrated herein that a single DataChip is sufficient to obtain the dose response of cells for each drug (or drug metabolite or drug candidate) in multiple replicates indicating the potential of the DataChip to be used in a high-throughput manner. Thus, a DataChip coupled with either a Drug Chip or MetaChip provides a reliable, fast, and efficient screening tool for toxicity assessment of drugs and their P450-generated metabolites, respectively, which can accelerate human toxicology assays for a large number of drug candidates that comprise the drug development process. It can be seen that the DrugChip can be incorporated into the MetaChip by including regions on the MetaChip that do not contain a P450 enzyme or other drug metabolizing enzyme. Moreover, the DataChip coupled with a Multizyme Chip provides a reliable, fast, and efficient tool for the generation and identification of optimized lead compounds for a large number of lead compounds that comprise the drug development process.

### Growth Inhibition Assay on a DataChip Coupled to a DrugChip

According to the present invention, the DataChip toxicology assay platform of the present invention can be used to assess the effects of test or lead compounds on cell growth or inhibition thereof by coupling the DataChip to a DrugChip.

In so doing, mammalian, preferably human, cell lines are encapsulated in a matrix arrayed atop a complementary pattern on a chemically modified or functionalized glass slide. The microscale array of the matrix containing the live cells are robustly attached onto the slides and the cells are grown in the gel spots as individual (e.g., separate) cells or small cellular clusters, which is a typical characteristic of large scale 3D cell culture. The three-dimensional cell chip (DataChip) is applied for in vitro growth inhibition assay with the Drug Chip containing various test or lead compounds, drugs or prodrugs by the stamping technique described herein.

It is demonstrated herein, that a DataChip comprising MCF7 human breast cancer cells encapsulated in a collagen matrix can be used to screen anticancer compounds including doxorubicin, 5-fluorouracil and tamoxifen.

In this embodiment, the DrugChip containing the drugs is prepared by dispensing 60 nL of different concentrations of drug solutions (doxorubicin, 5-fluorouracil, and tamoxifen varied from 0 to 1 mM) on top of dried collagen spots (30 nL each, 14×40 array). The drugs are spotted with one dose per row and a single DataChip was sufficient to test the entire range of concentrations of drugs in multiple replicates.

To alleviate the problem of altered drug concentration as a result of uneven evaporation, the drug solution is allowed to dry completely and was re-dissolved by quickly dispensing 60 nL of cell culture media (DMEM) atop each drug spots.

### Growth Inhibition Assay on a DataChip Coupled to a MetaChip

In cases where drug-metabolizing enzymes including cytochromes P450 existing in the liver convert less active compounds into more active products, it is desirable to screen the compounds based on the toxicity of their metabolites. As model systems, the DataChip toxicology assay platform is used to test the cytotoxicity of P450-generated metabolites by coupling the DataChip to a MetaChip.

For example, it is demonstrated herein that a DataChip in conjunction with a MetaChip, can also be used to test the cytotoxicity of P450-generated metabolites of two commonly used anticancer prodrugs, cyclophosphamide (CP) (Cytoxan®) and 5-fluoro-1-(tetrahydro-2-furfuryl)-uracil (Tegafur®). These are metabolized to the cytotoxic 4-hydroxycyclophosphamide and 5-fluorouracil by CYP3A4 and CYP1A2 reaction, respectively.

Other prodrugs or potential prodrugs, as test or lead compounds may also be investigated for cytotoxicity using the DataChip platform incorporating a MetaChip. These include, but are not limited to, 2,4-Dihydroxyphenylalanine, a prodrug for 6-hydroxydopa, which is converted by polyphenols oxidase; 5-fluoro-2-pyrimidinone (5-FP), a prodrug for 5-fluorouracil, which is converted by aldehyde oxidase; paclitaxel-2-ethylcarbonate, a prodrug for paclitaxel, which is converted by carboxyesterase; valacyclovir, prodrug of the anti-herpetic acyclovir, which is converted by esterases or related enzymes. In addition to prodrugs, protoxicants can be used. For example, acetaminophen is converted by the MetaChip into the corresponding iminoquinone, which is a cytotoxic agent. Therefore, the DataChip-MetaChip combination can be used to test for the activation of prodrugs and for the toxicity of metabolizing enzyme-generated metabolites of a wide range of drugs and drug candidates.

Advantageously, the DataChip uses cells incorporated into a 3D format, which represents an environment that closely approximates human cells in vivo. Thus, the current invention provides for a promising platform for quick and efficient validation of a battery of test and lead compounds, and may be used to correlate the IC₅₀ of these compounds with the LD₅₀ obtained from in vivo animal studies.

### Other Applications

According to the present invention, the DataChip toxicology assay platform may be exploited to provide more realistic physiologic multi-parameter measurements as the platform emulates native microenvironments.

The three-dimensional cell chip (DataChip) can also be extended to study more specialized toxicity response studies, including assays to monitor signal transduction pathways and cellular responses at the transcriptional/translational levels and also assays to measure apoptosis. Therefore, the DataChip platform promises to be a valuable tool for high throughput toxicology assays and opens up opportunities for rapid, inexpensive and convenient assessment of toxicity in vitro.

Utilizing such a reliable representation of microenvironments, the DataChip platform represents a promising platform for quick and efficient validation of a battery of compounds, and may be used to correlate the IC₅₀ of these compounds with the LD₅₀ obtained from in vivo animal studies.

In a further embodiment, the DataChip platform may be tailored to mimic the reactivity of drug candidates in different segments of the population, and even to individual patients, a critical precursor to the widespread adoption of personalized medicine.

It may also be used for investigations of microscale tissue engineering as combinatorial matrices and peptide mixtures can be formulated for cellular growth and differentiation studies.

It is also contemplated that the present invention may be used to determine the fate of single cells in the context of proliferation and/or apoptosis in response to different signals including extracellular matrix, drugs or growth factors.

### EXAMPLES

### Example 1

### Cell Culture

MCF7 human breast cancer cells (ATCC) were grown in Dulbecco's Modified Eagle's Medium (DMEM from Sigma, St. Louis, Mo.) supplemented with 5% fetal bovine serum (FBS from Invitrogen, Carlsbad, Calif.) and 1% penicillin-streptomycin (Invitrogen) in T-25 cell-culture flasks in a humidified 5% CO₂ incubator (ThermoForma Electron Co., Marietta, Ohio) at 37° C. Confluent layer of cells were sub-cultured every 2-3 days by trypsinization with 0.05% trypsin-0.53 mM EDTA (Invitrogen). Cell suspension was prepared by trypsinizing confluent cell monolayer and resuspending the cells in 5% FBS-supplemented DMEM to a concentration of 4.5×10⁶ cells/mL.

Hep3B human hepatoma cells (ATCC) were grown in Roswell Park Memorial Institute (RPMI) medium 1640 supplemented with 10% FBS and 1% penicillin-streptomycin in T-25 cell-culture flasks. Confluent layer of cells were sub-cultured every 2-3 d by trypsinization with 0.05% trypsin-0.53 mM EDTA (Invitrogen). Cell suspension was prepared by trypsinizing confluent cell monolayer and resuspending the cells in 5% FBS-supplemented DMEM to a concentration of 9×10⁶ cells/mL.

### Example 2

### Chemical Modification or Functionalization of Glass Substrates

For the very even silanization of a glass surface, the silanol group (—SiOH) on the surface was exposed by removing all dirt with strong acids. Borosilicate microscope slides (25×75 mm² from Fisher, Pittsburgh, Pa.) were placed in a removable glass slide rack (Fisher) and immersed in a solution of methanol:HCl (1:1 v/v) for 2 hr.

After rinsing the slides in de-ionized distilled water (dd H₂O) twice, the slides were further cleaned in concentrated sulfuric acid (96.5%) for 2 hr. After rinsing acid-cleaned slides in dd H₂O five times, the slides were rinsed once in acetone and exposed to nitrogen gas stream to dry.

Amino group functionalization on the slide surface was achieved by using 3-(aminopropyl) trimethoxysilane (APTMS from Sigma) in toluene. Briefly, the acid-cleaned slides were immersed in 5% (v/v) of APTMS in toluene containing 0.5% (v/v) of methylene chloride and sonicated for 1 h.

Following washing the slides by dipping in toluene three times and acetone once, the slides were dried with a stream of nitrogen and baked at 120° C. for 1 h. To remove any uncoupled APTMS, the slides were immersed in ethanol and sonicated for 30 min. After drying, the NH₂-functionalized slide was spin-coated at 3000 rpm for 30 seconds (Spin coater Model PWM32, Headway Research, Inc.) with 1.5 mL of 0.05% (w/v) of poly(styrene-co-maleic anhydride) (PS-MA from Sigma) in toluene. Hydrophobic treatment of the slide with amine-reactive PS-MA was adopted to covalently attach collagen and to prevent spreading of aqueous spots on the surface of the glass slide. The APTMS-PS-MA-treated slides were stored in a sterile petri dish until used.

As a comparison, the conventional method of protein attachment was also examined using glutaraldehyde treatment, which included the reaction of glutaraldehyde with the amino groups of APTMS bound to the substrate. The background fluorescence (see Example 3 below) from slides treated with glutaraldehyde was significantly higher indicating that glutaraldehyde did not completely react with amine groups on the surface.

The NH₂-functionalized slides were rinsed in series with acetonitrile (ACN), ACN:dd H₂O (1:1 v/v) and dd H₂O to wet the surface and immersed in 5% (v/v) of glutaraldehyde in Dulbecco's phosphate-buffered saline (PBS from Invitrogen) without CaCl₂ & MgCl₂. After sonication for 1 h, the slides were rinsed three times by dipping in dd H₂O to remove unbound glutaraldehyde.

It was also observed that the collagen spots formed uniformly hemispherical structures without uneven spreading on the PS-MA treated slides, but not on glutaraldehyde-treated slides. While not wishing to be bound by theory, it is believed that the superiority of the surface treated with PS-MA is because of reactive maleic anhydride groups covalently attaching collagen gels and the hydrophobic nature of polystyrene preventing the spread of collagen spots.

### Example 3

### Measurement of Amine Density by Fluorescein Isothiocyanate (FITC) Labeling

To monitor the amine density on the slide at different stages of slide treatment, the amine groups on the surface was labeled with green fluorescent FITC after modification with APTMS, PS-MA, and collagen.

The stock solution of fluorescein isothiocyanate (FITC) was prepared by dissolving reactive FITC dye (FluoReporter® protein labeling kit from Molecular Probes) in 50 μL of DMSO and the working solution was prepared by diluting the stock solution with 200 mL of 50 mM potassium phosphate buffer (pH 8). The slides were incubated in the dye solution for 1 hr with gentle magnetic stirring. After washing the slides three times in dd H₂O to remove unbound dye, the slides were dried by rinsing in acetone and exposing to nitrogen gas stream. The green fluorescence intensity on the slides was measured using a GenePix® Professional 4200A scanner (Molecular Devices Co., Sunnyvale, Calif.) equipped with blue laser (excitation 488 nm) and standard blue filter (emission 508-560 nm).

The green fluorescent intensity increased dramatically after modification of the acid-cleaned slide with APTMS due to the large number of amine groups that attach to silanol groups on the glass surface from APTMS and decreased to background level after subsequent treatment with PS-MA, indicating that PS-MA completely cover the surface blocking all amine groups. Further, on dispensing collagen spots on PS-MA treated slides, the green fluorescent intensity increased moderately because of the exposed amine groups from collagen.

### Example 4

### Preparation of the Three-Dimensional Cell Chip (DataChip)

Collagen DataChip

A suspension of collagen and cells was prepared by mixing collagen solution with the MCF-7 cell suspension in 5%-FBS supplemented DMEM on ice so that the final concentration of collagen and cells are 1.3 mg/ml and 3×10⁶ cells/mL, respectively.

Type I collagen from rat tail (3.9 mg/mL from BD Biosciences, Bedford, Mass.) was diluted with sterile PBS on ice to a final concentration of 2 mg/mL. The diluted collagen solution was spotted onto the PS-MA-treated slides (30 mL spot, 14×40 spot array) using a MicroSys™ 5100-4SQ microarrayer equipped with an extended head (Cartesian Technologies, Irvine, Calif.). This bottom layer of collagen without cells facilitates attachment of upper collagen layer and prevents unwanted cell spreading and 2D cell growth directly onto the slide.

Following drying for 10 minutes in a sterile petri dish, 30 mL of 1.25 mg/mL hyaluronan from Streptococcus equi (Sigma) in 0.05 N NaOH PBS solution was dispensed atop each collagen bottom spot using the microarrayer, and was allowed to dry. Since the collagen-cell suspension gels quickly, care was taken to ensure that the collagen-cell suspension was spotted within 10 min.

A 60 nL volume of the collagen-encapsulated cell suspension was then immediately spotted atop each collagen spot overlaid with hyaluronan. The humidity in the chamber of the microarrayer was maintained at 90% to retard evaporation of water during spotting. The DataChip slide with the collagen-gel drops containing MCF7 cells was quickly covered with a sterile glass slide separated by a 1 mm-thick gasket (McMaster-Carr) to prevent drying of the gel spots.

After 30 minutes of gelation, the three-dimensional cell chip was placed in a 100 mm-diameter petri dish containing 16 mL of 5% FBS supplemented DMEM and incubated in the CO₂ incubator at 37° C. for 18 hr prior to exposing the cells to test compounds (drugs or drug metabolites) by the stamping process.

### Confirmation of Live Cells and Growth Assessment

Confirmation of live cell count was performed using fluorescence studies whereby live cells were stained with the green fluorescent dye. Green dots represent live MCF7 cells in the collagen-gel drops. Deviation in spot-to-spot fluorescence due to printing error was less than 15%. Fluorescent read-out was calculated as a function of the cell number by calculating the intensity of spots seeded with different cell densities and a linear relationship over the range of interest was found.

To assess the growth of collagen encapsulated MCF7 cells on the three-dimensional cell chip (DataChip), the fluorescence of live cells were monitored over a 5-day period, which is typically the duration of in vitro toxicology assays. The scanned images of the MCF7 cells in the collagen-gel drops showed that the cells were viable and healthy in the collagen spots and the green fluorescence increases during the period of incubation. The cells were seen to grow as individual cells or as small colonies, characteristic of 3D cultures. On quantification of the fluorescent intensity, the MCF7 cells encapsulated in the collagen-gel drops showed a linear growth rate up to 5 days of incubation, beyond which it saturated. Similar growth curves were also observed for human hepatoma cells, Hep3B and human embryonic kidney cells, A293T.

### Example 5

### Growth Inhibition Assay with Anticancer Drugs on the Three-Dimensional Cell Chip (DataChip)

Growth inhibition assays were performed with the three-dimensional cell chip (DataChip) coupled with various anticancer drugs spotted on a complementary collagen-patterned slide (Drug Chip). Different concentrations of drugs including doxorubicin, 5-fluorouracil, and tamoxifen (all from Sigma) were prepared in PBS (0-1000 μM) and 60 nL of the drug solution was spotted atop a complementary pattern of dried collagen (30 nL spot, 14×40 spot array) on the PS-MA-treated slides using the microarrayer. After allowing the spots to dry, 60 nL of 5% FBS-supplemented DMEM was spotted atop the collagen-drug spots.

Simultaneously, the three-dimensional cell chip (DataChip) was removed from the petri dish and the excess liquid was drained off. Since it is crucial to keep the collagen spots hydrated for proper cell viability, caution was exercised to keep the three-dimensional cell chip from drying.

After spotting DMEM, the DataChip was immediately manually stamped atop the corresponding slide containing the drug solutions (DrugChip), so that each DataChip collagen spot containing cells made a one-on-one contact with each DrugChip collagen spot containing drug. For efficient contact of spot pairs allowing the transfer of drugs to the cells, the DrugChip contained a 250-μm thick silicone gasket (McMaster-Carr), which helped to maintain a suitable distance between the two slides and prevented drying of the cells during incubation.

During stamping the drugs were transferred to the cells through a cylindrical liquid column formed between the collagen-gel drops containing the cells and the drug spots. After stamping incubation for 6 hr at 37° C., the DataChip was separated from the DrugChip, rinsed twice with sterile PBS to remove any excess drug solution, and immersed in DMEM for 2 hr to allow for residual drugs to diffuse out from the collagen-gel drops. The DataChip was then transferred to a petri dish containing 16 mL of 5% FBS-supplemented DMEM and cultured for 3 days in the CO₂ incubator at 37° C. before staining for live cells.

### Example 6

### Collagen Encapsulation of Cytochrome P450

A P450-collagen solution (120 μL) was prepared on ice by mixing 24 μL of CYP3A4 baculosomes (1.1 nmol P450/mL from Invitrogen), 24 μL of 100 mM potassium phosphate buffer (pH 8.0), 12 μL of a regeneration system (333 mM glucose-6-phosphate and 40 U/mL glucose-6-phosphate dehydrogenase in 100 mM potassium phosphate buffer, pH 8), and 60 μL of Type I rat tail collagen (3.9 mg/mL). To ensure stable and hemispherical P450-collagen spots on the surface, 30 nL of the P450-collagen solution was spotted onto the PS-MA-treated slide using the microarrayer and was allowed to gel for 2 hr at room temperature before use. CYP1A2 was also encapsulated in the collagen gel using a similar method. P450 reactions were performed in 560-spot arrays consisting of 14×40 spots (30 nL each) by dispensing 60 nL of prodrug solution including cyclophosphamide (CP) or Tegafur® (both from Sigma) atop each P450 collagen spot.

### Example 7

### Cell Staining, Scanning, and Data Analysis

The cytotoxicity of drugs (or drug metabolites) was determined by staining the slide containing the cells with a Live/Dead test kit (Molecular Probes) that produces a green fluorescent response from living cells. At the end of the 3-day culture period post stamping, the three-dimensional cell chip (DataChip) was rinsed three times in PBS for 5 min each. One mL of a dye solution containing 0.5 μM calcein AM was applied to each three-dimensional cell chip using a glass slide with 1 mm thick perimeter gasket acting as a barrier to prevent loss of the dye solution.

Following incubation for 50 minutes at room temperature, excess dye in the collagen-gel drops was removed by incubating the slides in a petri dish containing 16 mL of PBS for 30 min on a gyratory shaker at 60 rpm. The three-dimensional cell chip was dried thoroughly with nitrogen. The three-dimensional cell chip was scanned with the GenePix® Professional 4200A scanner equipped with blue laser and standard blue filter to determine the green fluorescent intensity and was quantified from the scanning image using GenePix Pro 6.0 (Molecular Devices Co.). Since the background green fluorescence of completely dead cells (following treatment with 70% methanol for 1 h) was negligible, the percentage of live cells was calculated using the following equation:

Percent live cells=(F_{Reaction}/F_{Max})×100

where FReaction is the green fluorescence intensity of the reaction spot and FMax is the green fluorescence intensity of untreated fully viable cells.

### Example 8

### Growth Inhibition Studies in a 96-Well Plate

As controls for the DataChip toxicology assay platform, cytotoxicity assays were performed in a 96-well plate (Fisher) with both 2D monolayer and 3D collagen cultures of MCF7 cells.

In each well of the 96-well plate, 100 μL of the cell suspension containing 6×10³ cells and 60 μL of collagen gel solution (1.3 mg collagen/mL) containing 18×10³ cells were transferred for 2D and 3D cultures, respectively. Following culturing in the CO₂ incubator for 1 day at 37° C., the cells were incubated with 100 μL of various concentrations of drug solutions, including doxorubicin, 5-fluorouracil, and tamoxifen, for 6 hr.

For the control experiments, an identical procedure for cell growth and exposure to drugs was followed as the three-dimensional cell chip (DataChip) but evaluated the live cell number using the conventional MTT assay. The MTT assay is often used for cytotoxicity studies in the 96-well plate platform.

The drug solutions were removed and replaced with 200 μL of 5% FBS-supplemented DMEM and the cells were cultured further for 3 days. The cytotoxicity of the drugs was determined by adding 50 μL of MTT (Sigma) solution (2.5 mg/mL) in sterile PBS into each well. Purple-colored MTT-formazan crystals, generated in metabolically active cells after 4-hr incubation at 37° C., were dissolved by removing the MTT solution and adding 250 μL of acidic isopropanol containing 0.05 N HCl. After shaking for 30 min to dissolve the formazan crystals, the absorbance was determined with a BioAssay Reader HTS 7000 Plus (Perkin Elmer, Norwalk, Conn.) at 570 nm. The absorbance read at 570 nm correlated linearly with cell numbers for both 2D and 3D cultures and was used as a measure of live cell population.

The cytotoxic profile of MCF7 cells obtained with the three-dimensional cell chip (DataChip) is similar to that of the two controls. The scanned image of the cells on the DataChip showed that there was no apparent spot-to-spot contamination on the DataChip, as each spot was spatially separated.

In preliminary studies, the IC₅₀ of doxorubicin dissolved in PBS, 5-fluorouracil in PBS, and tamoxifen in PBS with 0.2% DMSO (due to limited solubility in water) evaluated on the DataChip were 869.0±57.0 nM, 51.5±3.3 μM, and 31.2±0.8 μM, respectively, whereas the IC₅₀ values from 2D control in the 96-well plate were calculated to be 64.7±4.4 nM, 41.7±4.6 μM, and 8.5±0.2 μM and the values from 3D control were 69.2±3.0 μM, 34.7±1.2 μM, and 28.8±0.2 μM, respectively.

Hence, IC₅₀ values obtained from the three-dimensional cell chip (DataChip) were comparable to those obtained from conventional 96-well plate platform with 2D cell monolayer and 3D cell culture.

### Example 9

### Growth Inhibition Assays on the Three-Dimensional Cell Chip (DataChip): MTMOS Functionalization of Substrate

For efficient stamping, MTMOS-coated glass slides were prepared to contain a sol-gel barrier on the periphery of the slides.

To this end 120 nL of methyltrimethoxysilane (MTMOS) sol was prepared by mixing 2 mL of MTMOS with 1 mL of HCl (10 mM) and sonicated for 10 min. The sol was spotted on the periphery of the MTMOS-coated slide and then the slide was baked in an oven for 30 min at 120° C. A MetaChip was prepared to contain CYP1A2, CYP2D6, CYP3A4, a mixture of the three P450s, and no-P450 control spots encapsulated in alginate spots and spotted onto the MTMOS-coated slide (Lee, M. Y., Park, C. B., Clark, D. S., and Dordick, J. S., Metabolizing enzyme toxicology assay chip (MetaChip) for high-throughput microscale toxicity analyses, Proceedings of the National Acadeny of Sciences of the United States of America (PNAS), 102, 983-987 (2005)).

The reactivity of the P450 isoforms was tested using blue fluorogenic substrates (see Example 10 for P450 activity determination). The MetaChip was stored at −80° C. for 1 day prior to use. Cytotoxicity studies were performed by spotting 20 nL of test compound in distilled water (0-2 mM) onto the MetaChip spots and partially dried.

To these spots, 20 nL solutions of DMEM, containing 2 mM NADP⁺ and its regeneration system (67 mM glucose-6-phosphate and 8 U/mL glucose-6-phosphate dehydrogenase in 20 mM potassium phosphate buffer, pH 8), were spotted. This was followed by stamping of the three-dimensional cell chip (DataChip) containing either MCF7 or Hep3B cells onto the MetaChip.

After incubating the stamped MetaChip-DataChip combination for 6 h at 37° C., the DataChip was removed, rinsed for 2 h, incubated for 3 days, stained, and scanned using the microarray scanner (see Example 7 for cell staining, scanning, and data analysis).

### Example 10

### P450 Activity Determination

To assess the intrinsic reactivity of P450s in alginate matrices, reactions were performed in wells of a 384-well plate. P450-containing alginate sol was prepared by dispensing 24 μL of P450 baculosomes (1 nmol P450/mL), 36 μL of distilled water, and 60 μL of alginate (2%) in distilled water. Five microliters of this solution were spotted onto 5 μL of the dried PLL-barium spot in a 384-well. Followed by storage of the P450-alginate gel drops at −80° C. for 1 day, 25 μL of blue fluorogenic substrates (BOMCC for CYP3A4 and EOMCC for CYP1A2 and CYP2D6) containing 250 μM NADP⁺ and its regeneration system (8 mM glucose-6-phosphate and 1 U/mL glucose-6-phosphate dehydrogenase) in 50 mM potassium phosphate buffer (pH 8) were dispensed onto the thawed P450-alginate gel drop.

As a control, soluble P450 without alginate was also used. The blue fluorescent 7-hydroxycoumarin released by P450-catalyzed oxidation of BOMCC or EOMCC was monitored as a function of time using a BioAssay Reader HTS 7000 Plus (Perkin Elmer, Norwalk, Conn.) at an excitation wavelength of 430 nm and emission wavelength of 497 nm.

To introduce P450 catalysis into the DataChip platform, the MetaChip (Metabolizing Enzyme Toxicology Assay Chip), which was used previously to assess the influence of P450 metabolism on prodrug and protoxicant activation, was modified to act as the test compound chip.

To this end, a MetaChip consisting of 20×54 alginate spots was prepared; each spot containing a single human P450 isoform (CYP1A2, CYP2D6, or CYP3A4), a mixture of the three isoforms, or no P450 as a test compound only control. Addition of test compounds was carried out by overlay spotting of solutions of these compounds onto the MetaChip, which was then stamped on top of the DataChip.

The high activity of the three P450 isoforms in the alginate matrix was confirmed and these data are shown in Table 1. In all cases the values of k_{cat}/Kₘ using a fluorogenic substrate were within a factor of two of the solution-phase reactions.

TABLE 1
Kinetic constants of P450 isoforms (1A2, 2D6,
and 3A4) obtained with blue fluorogenic substrate:
control (in solution), and in alginate.

| | Encapsu- | | | |
|---|---|---|---|---|
| P450 | lation | k_{cat} | Kₘ | K_{cat}/Kₘ |
| Isoform | matrix | (min⁻¹) | (μM) | (M⁻¹ min⁻¹ |
| CYP1A2 | Soluble | 1.35 ± 0.08 | 5.78 ± 0.80 | (2.34 ± 0.14) × 10⁵ |
| | enzyme | | | |
| | In | 0.51 ± 0.31 | 3.61 ± 0.43 | (1.31 ± 0.09) × 10⁵ |
| | Alginate | | | |
| CYP2D6 | Soluble | 0.12 ± 0.03 | 12.54 ± 4.64 | (9.57 ± 1.99) × 10³ |
| | enzyme | | | |
| | In | 0.07 ± 0.01 | 6.37 ± 1.25 | (1.10 ± 0.01) × 10⁴ |
| | Alginate | | | |
| CYP3A4 | Soluble | 7.51 ± 0.48 | 33.70 ± 2.94 | (2.23 ± 0.14) × 10⁵ |
| | enzyme | | | |
| | In | 4.65 ± 0.87 | 35.41 ± 8.98 | (1.31 ± 0.24) × 10⁵ |
| | Alginate | | | |

### Example 11

### Cytotoxicity Profiles and Dose Response Studies

The DataChip toxicology assay platform was evaluated using the cytotoxic response of MCF7 cells to varying doses of a three model compounds—doxorubicin (DOX), 5-fluorouracil (5-FU), and tamoxifen (TAM)—all of which are known to be cytotoxic to MCF7 cells. To this end, 60 nL of each compound at concentrations up to 1 mM was dispensed onto a slide containing only the dried collagen spots in a 14×40 array (e.g., without the addition of the subsequent three-dimensional collagen sol-gel). This array was then stamped on top of the DataChip and the dual slide system was incubated for 6 h at 37° C. As before, the cells on the DataChip were seeded at a density of 10⁶ cells/mL.

At the end of the stamping period, any excess compound that accumulated in the collagen-gel cell spots was washed out and the cells were grown for additional 3 days before measuring cell viability.

Calculated IC₅₀ values on the DataChip for DOX, 5-FU, and TAM are summarized in Table 2 along with IC₅₀ values for MCF7 cells grown in both 2D monolayer and 3D collagen-gel cultures in conventional 96-well plates, as well as literature values for 2D cultures in 96-well plates. IC₅₀ values obtained from the DataChip were comparable to those obtained from a conventional 96-well plate platform with both 2D cell monolayer and 3D cell culture.

TABLE 2
Calculated IC₅₀ values for the DataChip platform
in comparison to 2D and 3D microtiter plate scale

| | 2D 96- | 3D 96- | Collagen | Alginate | Alginate | |
|---|---|---|---|---|---|---|
| | well | well | DataChip | DataChip | DataChip | 2D literature |
| Drug | plate | plate | (MCF7) | (MCF7) | (Hep3B) | values |
| Doxorubicin | 0.06 ± 0.01 | 0.23 ± 0.02 | 0.43 ± 0.09 | 0.19 ± 0.08 | 0.29 ± 0.09 | 0.01-55 |
| | | | | | | Refs: 1-3 |
| 5-Fluorouracil | 68.9 ± 13.5 | 49.0 ± 3.0 | 82.4 ± 10.3 | 84.6 ± 18.7 | 66.1 ± 8.8 | 4.1-30.0 |
| | | | | | | Refs: 1, 2 |
| Tamoxifen | 4.44 ± 0.32 | 17.3 ± 3.2 | 10.1 ± 1.8 | 13.3 ± 4.8 | 19.9 ± 7.7 | 1.0-8.0 |
| | | | | | | Refs: 4, 5 |

1. Knuefermann, C., Lu, Y., Liu, B., Jin, W., Liang, K., Wu, L., Schmidt, M., Mills, G. B., Mendelsohn, J., and Fan, Z., HER2/PI-3K/Akt activation leads to a multidrug resistance in human breast adenocarcinoma cells, Oncogene, 22, 3205-12 (2003)
2. Li, D., Jang, S. H., Kim, J., Wientjes, M. G., and Au, J. L., Enhanced drug-induced apoptosis associated with P-glycoprotein overexpression is specific to antimicrotubule agents, Pharmaceutical Research, 20, 45-50 (2003)
3. Fujita, T., Washio, K., Takabatake, D., Takahashi, H., Yoshitomi, S., Tsukuda, K., Ishibe, Y., Ogasawara, Y., Doihara, H., and Shimizu. N., Proteasome inhibitors can alter the signaling pathways and attenuate the P-glycoprotein-mediated multidrug resistance, International Journal of Cancer, 117, 670-682 (2005)
4. Dhiman, H. K., Ray, A. R., and Panda, A. K., Three-dimensional chitosan scaffold-based MCF-7 cell culture for the determination of the cytotoxicity of tamoxifen, Biomaterials, 26, 979-86 (2005)
5. Kim, I. Y., Han, S. Y., and Moon, A., Phthalates inhibit tamoxifen-induced apoptosis in MCF-7 human breast cancer cells, Journal Toxicology Environmental Health A, 67, 2025-35 (2004)

Several things are apparent from these results.

First, the similarity among IC₅₀ values for the DataChip and 2D/3D cell cultures in 96-well plates (all within one order of magnitude and within published values) suggests that the DataChip is able to yield accurate cytotoxicity information.

Second, despite the ca. 2.000-fold scale down for the DataChip when compared to more conventional plate assays, the apparent accuracy of cytotoxicity data is not adversely affected.

Finally, the stamping procedure is performed for 6 h, yet for more conventional growth inhibition studies the drug or drug candidate remains in contact with the cells for anywhere from 1-7 days. Thus, the DataChip provides a matrix that enables rapid cellular uptake that results in sufficient exposure to deliver a representative cytotoxic dose.

Dose response cytotoxicity profiles for all three compounds on MCF7 cells were performed and showed similar profiles by all three methods.

### Example 12

### Alginate DataChip

Despite the ability of collagen to serve as a useful 3D matrix for human cell culture on the microscale, the material rapidly gels, thereby limiting the time that a cell-seeded collagen sol could remain in the solution state. Moreover, at longer incubation times the collagen matrix degraded, perhaps due to the presence of proteases in the cell culture, which resulted in the leaching of cells out from the 3D matrix.

To overcome these problems, an alginate gel matrix was used, which remained in the sol state in the absence of a bivalent metal ion and, therefore, allowed more control over DataChip preparation including the generation of spot volumes as small as 20 nL. Moreover, alginate is inert to proteinase-catalyzed degradation.

The alginate-containing three-dimensional cell chip (DataChip) was prepared as follows. A poly-L-lysine (PLL)-barium mixture was prepared by mixing equal volume of sterile PLL (0.01 w/v % from Sigma) and barium chloride solution in distilled water (0.1 M from Sigma).

A suspension of cells in low-viscosity alginate (from Sigma) was prepared by mixing a Hep3B cell suspension in 5% FBS-supplemented DMEM with alginate solution in distilled water so that the final concentration of cells and alginate are 6×10⁶ cells/mL and 1% (w/v), respectively.

Following spotting and drying of 10 nL PLL-barium mixture on the PS-MA-treated slide, 20-nL of the cell suspension (MCF7 or HepB3; cell density of 6×10⁶ cells/mL or 120 cells per spot) in alginate was spotted atop each PLL-barium spot. The use of barium as opposed to the more common calcium was predicated on the stability of the former in the presence of phosphate, which is a common constituent of cell culture media. The positively charged PLL assisted in attachment of the negatively charged polysaccharide constituent of alginate once gelation ensued.

After nearly instantaneous gelation due to the interaction of the alginate solution with Ba²⁺ ions, the alginate-based DataChip was placed in 5% FBS-supplemented DMEM and incubated in the CO₂ incubator at 37° C. for 18 h prior to exposing the cells to test compounds (drugs or drug metabolites) by the stamping process described herein.

Employing the DataChip platform as described herein, it was found that the alginate matrix supported growth of both MCF7 and Hep3B cells and enabled dose responses to DOX, 5-FU, and TAM that were similar to that obtained with collagen. Thus, alginate provides a suitable alternative to collagen.

### Example 13

### DataChip Miniaturization

In order to increase throughput of the DataChip, a 20×54 (1,080) spot DataChip using 20 nL cell culture spot volumes with alginate was prepared.

In addition, to extend the functional utility of the DataChip platform, P450-catalyzed drug metabolism was combined with the DataChip, thereby converting the platform into a drug metabolizing cytotoxicity screening system. P450s, primarily in the liver, catalyze the first-pass metabolism of xenobiotics, thereby generating one or more metabolites, some of which may be more or less toxic than the parent compound (Furge, L. L. and Guengerich, F. P., Cytochrome P450 enzymes in drug metabolism and chemical toxicology: an introduction, Biochem Mol Biol Educ, 34, 66-74 (2006); Guengerich, F. P., Cytochrome P450s and other enzymes in drug metabolism and toxicity, AAPSJ. 8, E101-E111 (2006)). Thus, the action of specific P450 isoforms can alter the cytotoxic dose responses of the DataChip.

### Example 14

### Determination of IC₅₀ Values

The cytotoxicities of a total of 27 compounds and their P450-generated metabolites were evaluated with human Hep3B and MCF7 cells, including Cytoxan®, Tegafur®, paclitaxel, doxorubicin, 5-FU, tamoxifen, lindane, nicotene, and acetaminophen, among others.

Using three DataChips in combination with three MetaChips, IC₅₀ values for 27 compounds and their P450-generated metabolites against human Hep3B cells were determined. These cells were non-induced and were expected to have essentially no intrinsic P450 activity. Consequently, they provide a useful model to assess hepatotoxicity on the DataChip platform. The three P450 isoforms were used along with an equimolar mixture of the three isoforms and a test compound only control without P450. The test compounds were added to the MetaChip, which was then stamped onto the DataChip and incubated for 6 h. This was followed by removing the DataChip, rinsing with growth medium, incubating in media for 3 days, and then stained for cell viability.

A single DataChip yielded information on the dose response of nine test compounds, each performed in one of 45 distinct regions of the DataChip consisting of a 4×6 mini-array that allowed six different doses of a test compound to be evaluated for cytotoxicity each with four replicates.

Results of these studies demonstrated that the DataChip platform is clearly able to rapidly identify metabolic activation or deactivation of xenobiotics through the action of P450 isoforms. These data are reported in Table 3.

TABLE 3
IC₅₀ values for compounds tested on the Hep3B DataChip

| | IC₅₀ values | | | | | | | | | |
|---|---|---|---|---|---|---|---|---|---|---|
| Compound | No P450 | | CYP1A2 | | CYP2D6 | | CYP3A4 | | Mixture | |
| Chloroquine | 189 ± 25.2 | μM | 184 ± 19.9 | μM | 112 ± 22.3 | μM | 79.7 ± 12.8 | μM | 94.5 ± 14.1 | μM |
| Isoniazid | >>1 | mM | 353 ± 89.9 | μM | >>1 | mM | >>1 | mM | >>1 | mM |
| Lindane | 394 ± 132 | μM | 2730 ± 1080 | μM | 5150 ± 1960 | μM | 523 ± 133 | μM | >>1 | mM |
| Orphenadrine | 20.5 ± 3.50 | μM | 179 ± 19.4 | μM | 169 ± 27.8 | μM | 116 ± 16.3 | μM | 83.8 ± 17.2 | μM |
| Pentachlorophenol | >>1 | mM | >>1 | mM | >>1 | mM | >>1 | mM | 489 ± 272 | |
| Quinidine | 19.2 ± 2.36 | μM | 92.9 ± 7.50 | μM | 106 ± 9.05 | μM | 126 ± 10.2 | μM | 246 ± 39.4 | μM |
| Thioridazine | 31.6 ± 31.6 | μM | 13.6 ± 1.08 | μM | 18.8 ± 1.22 | μM | 46.6 ± 3.96 | μM | 35.4 ± 3.18 | μM |
| Verapamil | 50.8 ± 3.83 | μM | 119 ± 12.5 | μM | 29.1 ± 2.34 | μM | 82.0 ± 15.6 | μM | 55.7 ± 10.5 | μM |
| Warfarin | >>1 | mM | >>1 | mM | >>1 | mM | >>1 | mM | >>1 | mM |
| Acetylsalicylic Acid | >>1 | mM | >>1 | mM | >>1 | mM | >>1 | mM | >>1 | mM |
| Amitriptyline | 31.7 ± 1.98 | μM | 75.0 ± 14.2 | μM | 55.9 ± 10.1 | μM | 63.4 ± 12.1 | μM | 75.6 ± 9.89 | μM |
| Digoxin | 0.80 ± 0.09 | μM | 1.29 ± 0.09 | μM | 0.43 ± 0.03 | μM | 1.37 ± 0.05 | μM | 0.59 ± 0.03 | μM |
| Atropine | 323 ± 86.0 | μM | 449 ± 150 | μM | 343 ± 96.3 | μM | 280 ± 69.1 | μM | 175 ± 46.1 | μM |
| Dichlorophenoxyacetic | >>1 | mM | >>1 | mM | >>1 | mM | >>1 | mM | >>1 | mM |
| acid | | | | | | | | | | |
| Nicotine | 29.5 ± 4.12 | μM | 90.8 ± 20.3 | μM | 158 ± 39.5 | μM | 647 ± 191 | μM | 377 ± 147 | μM |
| Theophylline | 38.4 ± 8.92 | μM | 239 ± 56.4 | μM | 119 ± 26.3 | μM | 36.9 ± 11.2 | μM | 84.3 ± 22.1 | μM |
| Propranolol | 95.9 ± 13.6 | μM | 69.4 ± 10.6 | μM | 74.6 ± 9.02 | μM | 86.0 ± 13.1 | μM | 86.1 ± 11.2 | μM |
| Paraquat | 79.8 ± 12.7 | μM | 5.06 ± 0.29 | μM | 20.8 ± 1.80 | μM | 52.0 ± 9.12 | μM | 44.2 ± 6.05 | μM |
| Cyclophosphamide | >>1 | mM | >>1 | mM | >>1 | mM | 2.11 ± 0.60 | mM | >>1 | mM |
| Tegafur | >>1 | mM | >>1 | mM | >>1 | mM | 54.8 ± 21.4 | mM | >>1 | mM |
| Acetaminophen | >>1 | mM | 2.59 ± 0.96 | mM | >>1 | mM | 2.77 ± 1.24 | mM | >>1 | mM |
| | | | (IC₃₀: 0.50 ± 0.02) | | | | | | | |
| 5-Fluorouracil | 196 ± 27.2 | μM | 218 ± 44.3 | μM | 132 ± 20.7 | μM | 349 ± 72.3 | μM | 436 ± 77.0 | μM |
| Tamoxifen | 83.0 ± 12.8 | μM | 113 ± 30.2 | μM | 28.4 ± 2.86 | μM | 398 ± 155 | μM | 63.8 ± 15.0 | μM |
| Doxorubicin | 0.69 ± 0.01 | μM | 1.01 ± 0.22 | μM | 4.94 ± 1.36 | μM | 19.3 ± 5.45 | μM | 9.71 ± 2.22 | μM |
| Methotrexate | 2.41 ± 0.55 | μM | 2.79 ± 0.73 | μM | 38.3 ± 12.1 | μM | 10.9 ± 2.76 | μM | 8.00 ± 2.97 | μM |
| Cytarabine | 8.65 ± 0.17 | μM | 48.8 ± 15.7 | μM | >>1 | mM | 12.4 ± 4.04 | μM | >>1 | mM |
| Paclitaxel | 3.33 ± 0.56 | μM | 4.16 ± 1.48 | μM | 14.7 ± 4.70 | μM | 6.50 ± 2.37 | μM | 5.52 ± 1.84 | μM |

Of the 27 compounds, 19 showed IC₅₀ values less than 1 mM and two (digoxin and doxorubicin) showed IC₅₀ values under 1 μM. In both cases, the values determined on the DataChip were similar to literature values for related cell types (Winnicka, K. and Bielawska, A., Inhibition of DNA topoisomerases I and II, and growth inhibition of breast cancer MCF-7 cells by ouabain, digoxin and proscillaridin A., Biological & Pharmaceutical Bulletin, 29, 1493-1497 (2006); Takara, K., Tsujimoto, M., Ohnishi, N., and Yokoyama, T., Effects of continuous exposure to digoxin on MDR1 function and expression in Caco-2 cells, Journal of Pharmacy and Pharmacology, 55, 675-681 (2003)).

Moreover, 19 compounds were reactive toward one or more of the P450 isoforms, as evidenced by statistically relevant activation or deactivation of the toxic response by the Hep3B cells. For example as expected CYP1A2 strongly activated acetaminophen, converting the compound into a cytotoxic metabolite. Similar activation by CYP1A2 is seen with paraquat (methyl viologen) by CYP1A2 and CYP2D6, as well as the mixture of the three P450 isoforms.

Examination of the full DataChip results revealed that CYP1A2 moderately to weakly deactivated lindane, orphenadrine, quinidine, verapamil, amitriptyline, nicotine, theophylline, and cytarabine. Similarly, CYP2D6 activated verapamil, tamoxifen, doxorubicin, and paraquat while deactivating lindane (strongly), orphenadrine, quinidine, nicotine, theophylline, methotrexate, cytarabine, and paclitaxel. CYP3A4 strongly activated acetaminophen and cyclophosphamide, which is consistent with the known prodrug and protoxicant activation of these compounds by this isoform (Huang, Z., Roy, P., and Waxman, D. J., Role of human liver microsomal CYP3A4 and CYP2B6 in catalyzing N-dechloroethylation of cyclophosphamide and ifosfamide, Biochemical Pharmacology, 59, 961-972 (2000); Anderson, D., Bishop, J. B., Garner, R. C., Ostrosky-Wegman, P., and Selby, P. B., Cyclophosphamide: Review of its mutagenicity for an assessment of potential germ cell risks, Mutation Research, 330, 115-181 (1995); Patten, C. J., Thomas, P. E., Guy, R. L., Lee, M. J., Gonzalez, F. J., Guengerich, F. P., and Yang, C. S., Cytochrome P450 enzymes involved in acetaminophen activation by rat and human liver microsomes, Chemical Research in Toxicology, 6, 511-518 (1993); Nelson, S. D., Mechanisms of the formation and disposition of reactive metabolites that can cause acute liver injury, Drug Metab. Rev., 27, 147-177 (1995)).

Finally, CYP3A4 deactivated chloroquine, quinidine, nicotine (strongly), 5-fluorouracil, tamoxifen, and methotrexate. Thus, the DataChip-MetaChip combination was able to accurately predict the influence of P450-catalyzed first-pass metabolism on a diverse number of xenobiotics.

For most of the reactive xenobiotics the IC₅₀ values of the P450 mixtures were within the range of IC₅₀ values for the individual P450 isoforms. Interestingly, however, both lindane and quinidine undergo greater deactivation in the mixture than with any of the three individual isoforms. This may be a result of multiple P450 catalysis by different isoforms, which results in greater structural modification of the xenobiotic and less toxicity. This is exacerbated by the fact that all three P450 isoforms are reactive toward both compounds.

While this invention has been particularly shown and described with references to preferred embodiments thereof, it will be understood by those skilled in the art that various changes in form and details may be made therein without departing from the scope of the invention encompassed by the appended claims.

What is claimed is:

1. A three-dimensional cell chip for microarray analysis comprising a chemically modified glass slide having spotted thereon a plurality of independent spots, each spot comprising:
(a) a matrix bottom layer, and
(b) a matrix surface layer containing cells.

2. The three-dimensional cell chip of claim 1 wherein the chemical modification of the glass slide comprises functionalization with 3-(aminopropyl)trimethoxysilane (APTMS) followed by functionalization with poly(styrene-co-maleic anhydride) (PS-MA).

3. The three-dimensional cell chip of claim 1 wherein the chemical modification of the glass slide comprises functionalization with a coating of methyltrimethoxysilane (MTMOS).

4. The three dimensional cell chip of claim 2 wherein the matrix bottom layer comprises a poly-L-lysine (PLL)-barium chloride mixture.

5. The three dimensional cell chip of claim 4 wherein the matrix of the matrix surface layer containing cells of (b) comprises alginate.

6. The three dimensional cell chip of claim 2 further comprising a middle layer deposited between said matrix bottom layer and said matrix surface layer containing cells.

7. The three dimensional cell chip of claim 6 wherein the middle layer comprises hyaluronan.

8. The three-dimensional cell chip of claim 2 wherein the matrix of the matrix bottom layer is selected from sol-gels, inorganic materials, organic polymers, hybrid inorganic-organic materials, biological materials, or any combination thereof.

9. The three-dimensional cell chip of claim 2 wherein the matrix of the matrix surface layer containing cells is selected from sol-gels, inorganic materials, organic polymers, hybrid inorganic-organic materials, biological materials, or any combination thereof.

10. The three-dimensional cell chip of claim 8 wherein the matrix of the matrix bottom layer is a biological material.

11. The three-dimensional cell chip of claim 10 wherein the biological material comprises Type I collagen.

12. The three-dimensional cell chip of claim 10 wherein the biological material comprises alginate.

13. The three-dimensional cell chip of claim 8 wherein the matrix of the matrix surface layer containing cells is a biological material.

14. The three-dimensional cell chip of claim 13 wherein the biological material comprises collagen.

15. The three dimensional cell chip of claim 13 wherein the biological material comprises alginate.

16. The three-dimensional cell chip of claim 2 comprising at least 1000, at least 3000 or at least 5000 independent spots.

17. The three-dimensional cell chip of claim 2 comprising at least 1080 independent spots.

18. The three-dimensional cell chip of claim 2 comprising at least 560 independent spots.

19. The three dimensional cell chip of claim 18 wherein each of the independent spots is about 0.6 mm in size with a center-to-center distance of about 1.2 mm.

20. The three-dimensional cell chip of claim 18 wherein the 560 independent spots are regularly spaced.

21. The three-dimensional cell chip of claim 1 wherein the cells contained within the matrix surface layer are encapsulated in a substantially regular pattern within the matrix.

22. The three-dimensional cell chip of claim 1 wherein the cells are mammalian cells.

23. The three-dimensional cell chip of claim 22 wherein the mammalian cells are selected from the group consisting of human hepatoma cells, Hep3B cells, human embryonic kidney cells, A293T cells and breast carcinoma cells, MCF-7 cells.

24. A method of preparing a three-dimensional cell chip for microarray analysis comprising the steps of:
(a) functionalizing a glass slide, wherein functionalization comprises treatment with 3-(aminopropyl)trimethoxysilane (APTMS) followed by treatment with poly(styrene-co-maleic anhydride) (PS-MA), and
(b) depositing a plurality of individual spots onto the functionalized glass slide said deposition comprising the steps of:
(i) depositing a plurality of individual spots comprising a matrix bottom layer atop the functionalized glass slide,
(ii) depositing a matrix surface layer containing cells on the surface of the matrix bottom layer of (i).

25. The method of claim 24 further comprising the step of (c) incubating the functionalized glass slide with deposited individual spots in cell culture media.

26. The method of claim 24 wherein the matrix of the matrix bottom layer comprises poly-lysine and barium chloride.

27. The method of claim 25 wherein the matrix of the matrix surface layer containing cells comprises alginate.

28. The method of claim 26 further comprising the step of (c) incubating the functionalized glass slide with deposited individual spots in cell culture media.

29. The method of claim 24 wherein the matrix of the matrix bottom layer comprises collagen and wherein the matrix of the matrix surface layer containing cells comprises collagen.

30. The method of claim 24 further comprising the step of depositing a middle layer between said plurality of individual spots comprising a matrix bottom layer atop the functionalized glass slide and said matrix surface layer containing cells on the surface of the matrix bottom layer.

31. The method of claim 30 wherein the middle layer comprises hyaluronan or its acid.

32. A process for assaying cytotoxic effects of test compounds on cells comprising the steps of:
(a) preparing a three-dimensional cell chip,
(b) preparing a test compound chip,
(c) stamping together the three-dimensional cell chip and the test compound chip, and
(d) calculating IC₅₀ values of the test compounds based on live cell count.

33. The process of claim 32 further comprising the step of (e) correlating IC₅₀ values of (d) with cytotoxicity profiles of the test compounds.

34. The process of claim 32 wherein the duration of stamping step (c) is about 6 hours.

35. The process of claim 32 wherein communication between the three-dimensional chip and the test compound chip during stamping occurs in an arrayed one-to-one pattern.

36. The process of claim 32 wherein the live cell count is measured using a fluorescence-based or calorimetric assay.

37. The process of claim 32 wherein the test compound chip comprises:
(a) a chemically modified glass slide having thereon a collagen spot array, and
(b) at least one test compound deposited atop each collagen spot of (a).

38. The process of claim 37 wherein the three-dimensional cell chip comprises:
(a) a chemically modified glass slide having thereon a collagen spot array comprising a collagen matrix bottom layer, and
(b) a collagen matrix surface layer containing cells deposited atop each collagen spot of (a).

39. The process of claim 37 wherein the three-dimensional cell chip comprises:
(a) a chemically modified glass slide having thereon a matrix spot array comprising a poly-lysine and barium chloride matrix bottom layer, and
(b) an alginate matrix surface layer containing cells deposited atop each matrix spot of (a).

40. The process of claim 32 wherein the test compound chip comprises:
(a) a chemically modified glass slide having thereon a collagen spot array,
(b) at least one drug-metabolizing enzyme encapsulated in each of the collagen spots arrayed in (a), and
(c) at least one test compound deposited atop each collagen spot arrayed in (a).

41. The process of claim 40 wherein the three-dimensional cell chip comprises:
(a) a chemically modified glass slide having thereon a collagen spot array comprising a collagen matrix bottom layer, and
(b) a collagen matrix surface layer containing cells deposited atop each collagen spot of (a).

42. The process of claim 40 wherein the three-dimensional cell chip comprises:
(a) a chemically modified glass slide having thereon a matrix spot array comprising a poly-lysine and barium chloride matrix bottom layer, and
(b) an alginate matrix surface layer containing cells deposited atop each matrix spot of (a).

43. The process of claim 42 wherein the at least one test compound is selected from the group consisting of a candidate drug, drug, a prodrug and a drug metabolite.

44. The process of claim 43 wherein the at least one test compound is selected from the group consisting of a candidate drug, drug and a prodrug.

45. The process of claim 44 wherein the test compound comprises a drug and wherein the drug is selected from the group consisting of doxorubicin, 5-fluoruracil, and tamoxifen.

46. The process of claim 43 wherein the test compound comprises a prodrug and wherein said prodrug is selected from the group consisting of cyclophosphamide (CP) and 5-fluoro-1-(tetrahydro-2-furfuryl)-uracil.

47. A microarray platform for toxicology assays comprising:
(a) a three-dimensional cell chip,
(b) a test compound chip, and
(c) a device for measurement of live cell count.
